(19) United States
(12) Patent Application Publication
(10) Pub. No.: US 2022/0181056 A1
(43) Pub. Date: Jun. 9, 2022

(54) Single Or Multi-Coil Toroid Based Solenoid

(71) Applicants: DENSO International America, Inc., Southfield, MI (US); DENSO CORPORATION, Kariya-city (JP)

(72) Inventors: Daniel MCGRAIL, Southfield, MI (US); Michael OZIKA, Novi, MI (US)

(21) Appl. No.: 17/110,746

(22) Filed: Dec. 3, 2020

(51) Int. Cl. H01F 7/08; H01F 7/16

(52) U.S. Cl. CPC H01F 7/081; H01F 2007/086; H01F 7/1607

(57) ABSTRACT

A solenoid includes a core, a yoke, and a first coil. The first coil is wound around the yoke.

### FIELD

The present disclosure relates to solenoid designs, and, more particularly, to a single or multi-coil toroid based solenoid.

### BACKGROUND

This section provides background information related to the present disclosure which is not necessarily prior art.

A solenoid converts electrical energy to mechanical energy. It uses an electric current to create a magnetic field and then generates linear motion from the magnetic field.

Conventional solenoid designs often include a core having a plunger and a stator core. A coil (or wire) is wound around a coil bobbin that is then inserted over the core. The core, coil bobbin, and coil assembly is then inserted in a yoke. In use, a magnetic field is created when electric current passes through the coil. The magnetic field generates a magnetic force that moves the plunger to close or reduce an air gap.

### SUMMARY

This section provides a general summary of the disclosure, and is not a comprehensive disclosure of its full scope or all of its features.

At least one example embodiment of a solenoid according to the present disclosure includes a core, a yoke, and a first coil. The first coil is wound around the yoke.

In at least one example embodiment, a second coil may be wound around the core and may be electrically connected to the first coil.

In at least one example embodiment, the core may include a stator core and a coil bobbin. The coil bobbin may be wrapped around the stator core, and the second coil may be wound around the coil bobbin.

In at least one example embodiment, the core may include a plunger disposed within an aperture defined by the stator core.

In at least one example embodiment, a diameter of the yoke may be the same as a diameter of the plunger.

In at least one example embodiment, a diameter of the yoke may be less than a diameter of the stator core.

In at least one example embodiment, the yoke may include a yoke spoke and a yoke bobbin. The yoke bobbin may be located around the yoke spoke and the first coil may be wound around the yoke bobbin.

In at least one example embodiment, the spoke may be a cylindrical yoke spoke, the yoke bobbin may be a cylindrical bobbin, and the first coil may be located around the yoke bobbin in a cylindrical shape.

In at least one example embodiment, the yoke spoke may be a plate-shaped yoke spoke, and the first coil may be located around the yoke bobbin in a stadium shape.

In at least one example embodiment, the yoke spoke may extend parallel to the core and may be attached to the core by arms extending between a top end of the core and a top end of the yoke spoke and between a bottom end of the core and a bottom end of the yoke spoke.

In at least one example embodiment, the yoke may be one of a pair of yokes and the first coil may be one of a pair of first coils. Each of the pair of yokes may include a yoke spoke, and one of the pair of first coils may be wound around the yoke spoke on each of the pair of yokes.

In at least one example embodiment, the pair of yokes may be disposed symmetrically and on opposing sides of the core.

In at least one example embodiment, the yoke spoke may be a cylindrical spoke, and the first coil may be wound around the yoke spoke in a cylindrical shape.

In at least one example embodiment, each of the pair of first coils may be supplied current around the spoke in a first direction, and the second coil may be supplied current around the core in a second direction. The second direction may be opposite the first direction.

In at least one example embodiment, the first coil may be supplied current around the yoke in a first direction, and the second coil may be supplied current around the core in a second direction. The second direction may be opposite the first direction.

In at least one example embodiment, the first direction may be counter-clockwise around the yoke, and the second direction may be clockwise around the core.

In at least one example embodiment, the first direction may be clockwise around the yoke and the second direction may be counter-clockwise around the core.

At least one example embodiment of a solenoid according to the present disclosure includes a core and a first coil. The core extends in a toroidal shape or a toroid-like shape. The first coil is disposed around the core.

In at least one example embodiment, the first coil may be disposed on an entirety of the core.

In at least one example embodiment, the first coil may be disposed on a portion of the core.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations are illustrated. The drawings of the selected embodiments herein are not intended to limit the scope of the present disclosure.

FIG. 1A is a perspective view of a prior art conventional solenoid.

FIG. 1B is a magnetic circuit representation for the solenoid in FIG. 1A.

FIG. 2A is a perspective view of at least one example embodiment of a solenoid according to the present disclosure.

FIG. 2B is a schematic cross-sectional view of at least one alternative example embodiment of a solenoid according to the present disclosure.

FIG. 2C is a schematic cross-sectional view of at least one alternative example embodiment of a solenoid according to the present disclosure.

FIG. 3A is a perspective view of at least one alternative example embodiment of a solenoid according to the present disclosure.

FIG. 3B is a cross-sectional view of the solenoid in FIG. 3A.

FIG. 4 is a magnetic circuit representation for the solenoid in FIG. 3A.

FIG. 5A is a perspective view of at least one alternative example embodiment of a solenoid according to the present disclosure.

FIG. 5B is a cross-sectional view of the solenoid in FIG. 5A.

FIG. 6A is a perspective view of at least one alternative example embodiment of a solenoid according to the present disclosure.

FIG. 6B is a cross-sectional view of the solenoid in FIG. 6A.

FIG. 7 is a magnetic circuit representation for the solenoid in FIG. 6A.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Solenoid designs generally include a core having a plunger and a stator core. A coil (or wire) is wound around a coil bobbin that is then inserted over the core. The core, coil bobbin, and coil assembly is then inserted in a yoke. In use, a magnetic field is created when electric current passes through the coil. The magnetic field generates a magnetic force that moves the plunger to close or reduce a gap, or an air gap. While the term “air gap” is used, it is understood that the gap does not strictly have to be air. The gap could be filled with other gasses or liquids (e.g., automatic transmission fluid, gasoline, diesel, etc.). Additionally, the gap or air gap may be referred to as an aperture in which the plunger is disposed.

When designing a solenoid, it is advantageous in many applications to achieve the desired armature force (or the force produced by the electromagnetic field) in the smallest volume possible. Maximum armature force in a minimum volume provides cost savings (reduced quantity of material required) and more versatility in packaging of the solenoid. One general method used to accomplish maximum armature force in a minimum volume is to minimize the magnetic circuit reluctance by tightening tolerances between ferromagnetic/magnetic components or choosing high magnetic permeability materials with a high saturation flux density. However, this method can be costly.

Another way to achieve maximum armature force (Newton, N) in the smallest volume possible is to maximize the magnetomotive force (Amp-Turn) by maximizing the number of coil turns (N), increasing the applied voltage (V), or decreasing the coil resistance (R) according to the equation:

N×V/R=magnetomotive force(mmf)

In many applications, the amount of available voltage is limited, such as by an automobile battery for example. Coil resistance will be determined by the wire diameter and length of wire. Thus while the magnetomotive force can be increased by increasing the number of coil windings, a longer length of wire is required for the increased coil windings, thereby increasing the resistance. To minimize the increase in resistance due to the longer wire length, the wire diameter can be increased. However, an increased wire diameter will require a larger volume of copper wire to be used to achieve the same number of coil turns.

Additionally, the coil windings are typically wrapped around a bobbin which is positioned in the space between the stator core and yoke. Efforts may be taken to maximize the number of windings which can package within this space. However, due to the inherent design of the bobbin, each subsequent outer layer of winding has a larger diameter than the preceding inner layer. This results in one loop of wire requiring a longer length of wire and therefore having a larger resistance than one loop of wire in a previous inner layer. Each layer that is wound over the first, innermost layer, produces less magnetomotive force since it has a higher resistance than the first, innermost layer.

Therefore it is apparent that maximizing the number of windings about the smallest diameter possible is advantageous. This is typically accomplished in one of two ways. One way is to minimize the stator core diameter, which the bobbin is typically inserted over, to achieve a smaller bobbin diameter. However, the stator core has a minimum acceptable diameter for a given design since reducing the diameter below the minimum limit will lead to magnetic saturation in the stator core and will be counterproductive to increasing magnetic force. A second typical way to maximize the number of windings at smaller diameter is to lengthen the bobbin. However, the tradeoff of increased length to diameter ratio can lead to undesirable effects, such as increased leakage flux, which may result in decreased magnetic efficiency, and thus reduced magnetic force.

The present disclosure is directed to a solenoid having an increased magnetomotive force per unit volume by maximizing a number of windings with minimal length wire. In at least one example embodiment, a solenoid may contain a toroidal-shaped ferromagnetic core. The shape of the solenoid results in a relatively long length and small diameter of wire, while leakage flux is minimized due to the toroidal shape.

In at least one example embodiment, a simplified toroidal shape may be created by winding two separate windings which flow current in opposite directions (clockwise vs counterclockwise). One coil is wound around the solenoid core and the other coil is wound around a single yoke spoke. The simplified toroidal shape results in a solenoid design with less coil winding and a slightly increased leakage flux compared to the solenoid having the toroidal-shaped ferromagnetic core. However, the simplified toroidal shape may be more easily manufactured than the solenoid having the toroidal-shaped ferromagnetic core.

In at least one example embodiment, a multi-spoke yoke solenoid may be utilized. A core may be wound with one coil, and all additional yoke spokes may also be wound. Winding the core and all additional yoke spokes allows for increased cross-sectional area in the cumulative magnetic circuit cross-sectional area to reduce magnetic saturation that may be observed in other solenoids. Additionally, many coil windings of decreased or minimized winding layer diameter generates the increased magnetomotive force.

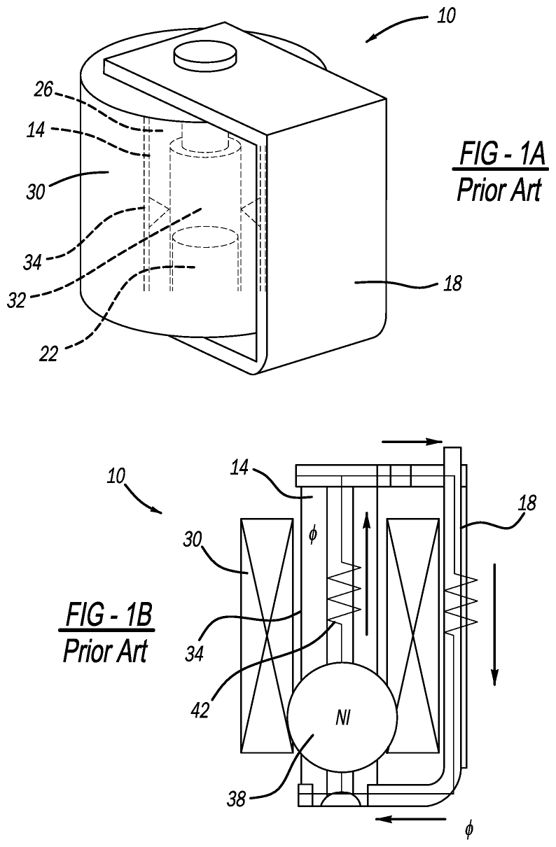

Now referring to FIGS. 1A and 1B, a conventional solenoid 10 is illustrated. In at least one example embodiment, the solenoid 10 includes a core 14 and a yoke 18. The core 14 may have a plunger 22 and a stator core 26. A coil (or wire) 30 is wound around a coil bobbin 34 that is inserted over the core 14. The core 14, coil bobbin 34, and coil 30 assembly is fully or partially surrounded by the yoke 18. In at least one example embodiment, the yoke 18 is a C-shaped yoke that connects to the core 14 on opposing ends.

In FIG. 1B, the magnetic circuit representation for the solenoid 10 is illustrated. With the coil 30 wound around the core 14 of the solenoid 10, the magnetic circuit can be represented with a source (NI) 38 located in the center of the solenoid 10. The source (NI) 38 is equivalent to the number of turns of the coil 30 multiplied by the current (i.e., supplied by a battery, for example). For reference, please see the following equations (i.e., Magnetic “Ohm's Law” or Hopkinson's Law and Electrical Ohm's Law, respectively):

NI=ϕR

V=IR

The source (NI) 38 is similar to a “voltage source” in a magnetic circuit. The magnetic circuit representation for the solenoid 10 may include at least one resistor symbol 42 representing a magnetic reluctance. It is understood that the number of reluctances may be arbitrarily defined using the magnetic circuit representation.

As the coil 30 is wound around the core 14 of the solenoid 10, the length of the wire to achieve one revolution around the core 14 increases with each successive layer. Thus, the outermost layer of wire requires more length of wire for a revolution than the first, or innermost, layer of wire because of the increase radius. The length of wire used for each loop can be calculated by finding the circumference of each loop:

Circumferenceₓ=2πrₓ

where x is the layer and r is the radius. Therefore, each successive layer of wire uses an increased amount of available resistance (i.e., because the length of wire increases).

In use, a magnetic field is created when electric current passes through the coil 30. The magnetic field generates a magnetic force that moves the plunger 22 to close or reduce an air gap 32.

The solenoid of the present disclosure increases the magnetomotive force (mmf) per unit volume by increasing the number of coil turns per unit volume by utilizing 1 or more coils wound around the core and the yoke of the solenoid. In at least one example embodiment, the yoke and core form a single toroidal-shaped body.

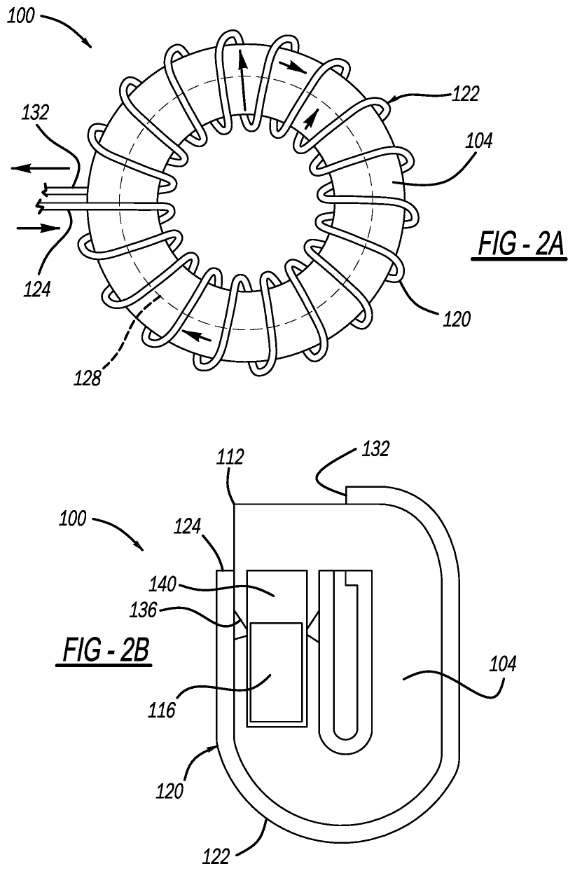

Now referring to FIGS. 2A-2C, at least one example embodiment of a solenoid 100 according to the present disclosure is illustrated. The solenoid 100 may include a core 104 having a toroidal shape. A toroidal shape includes a toroidal polyhedron and is formed by rotating a two-dimensional shape (for example, a circle, an ellipse, a circular sector, a semicircle, a crescent, a polygon, etc.) around an axis of rotation to create a surface of revolution on a solid body with an aperture in the middle (for example, a torus, ring, or doughnut shape is formed by rotating a circle around an axis of rotation). A toroid is a special shape which has theoretically no leakage flux when wound with a wire as shown in FIG. 2A, despite having a potentially long length of wire. There are two key benefits, in particular, to designing a solenoid with this shape. First, the shape allows for nearly the entire solenoid core to be wrapped in coil windings and the number of windings at a small diameter to be maximized. Therefore, fewer winding layers, as shown in FIGS. 2B and 2C, can be used to generate the magnetomotive force (mmf). Second, unlike the elongated solenoid previously discussed, the toroid shape minimizes leakage flux, which allows more of the flux to translate to magnetic force on the plunger (described below).

In at least one alternative example embodiment, the core 104 may have a nearly toroidal shape, or a toroid-like shape, as shown in FIGS. 2B and 2C. The nearly toroidal shape in FIGS. 2B and 2C may have the same benefits as the toroid shape in FIG. 2A. In at least one example embodiment, the nearly toroidal shape may be an oval shape or a partially oval shape having a single corner 112.

In at least one example embodiment, the solenoid 100 includes a plunger 116 and a coil 120. The plunger 116 may be disposed within a portion of the core 104 as shown in FIGS. 2B and 2C. The coil 120 may be formed of wire. The coil 120 may be wrapped around the core 104 in a helical shape, creating a layer of coil windings 122 around the core 104. In at least one example embodiment, the layer of coil windings 122 may be a continuous layer of wire formed by the coil windings being wrapped about the core 104 such that the current winding abuts the portion of coil from the previous winding without a gap therebetween. In at least one example alternative embodiment, the layer of coil windings 122 may include windings that have gaps therebetween such that the layer is not a continuous layer of wire. It is understood that the number of layers of coil windings is design dependent, and the present disclosure is applicable for any number of layers of coil windings.

In at least one example embodiment, if the core 104 is a toroid shape, such as in FIG. 2A, the coil 120 may be wrapped entirely around the core 104. In at least one alternative example embodiment, if the core 104 is a nearly toroidal shape, such as in FIGS. 2B and 2C, the coil 120 may be wrapped either entirely around the core 104 or around a portion of the core 104. For example, the coil 120 may be wrapped around an entirety of the core 104 except for the corner 112. Wrapping the coil 120 around a portion of the core 104 may allow for easier manufacturing and may provide reduced manufacturing costs and labor time.

As shown in FIG. 2A, current (I) may enter the coil 120 of the solenoid 100 on a first end 124 of the coil 120, the current (I) may travel in the helical pattern through the coil 120 around the core 104, creating a flux path 128 in the core 104, and the current (I) may exit the solenoid 100 on a second end 132 of the coil 120. The flux path 128 is illustrated as the dashed line in FIG. 2A. A similar current (I) path and flux path occurs in the nearly toroidal shape illustrated in FIGS. 2B and 2C. The current (I) enters the coil 120 on the first end 124, travels in the helical pattern through the coil 120, and exits the coil 120 on the second end 132.

In use, a magnetic field is created when electric current passes through the coil 120 and generates the flux path 128. The magnetic field may produce a magnetic force that is representative of a variable force solenoid (FIG. 2B) or an on-off type solenoid (FIG. 2C). The variable force solenoid (FIG. 2B) may be accomplished by generating magnetic force on the armature by directing magnetic flux from the plunger 116 through a tapered section 136 of the stator core 104. Alternatively, the variable force solenoid may be accomplished using other conventional techniques. The on-off type solenoid (FIG. 2C) may be accomplished by designing an air gap 140 to be relatively small (smaller than the air gap 140 in FIG. 2B) so that magnetic flux generates almost purely axial force on the plunger 116 to pull it towards the core 104. Alternatively, the on-off type solenoid may be accomplished using other conventional techniques.

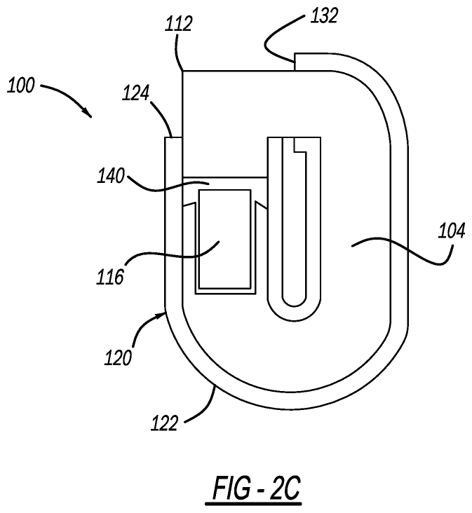

Now referring to FIGS. 3A and 3B, at least one example embodiment of a solenoid 200 according to the present disclosure is illustrated. The solenoid 200 may have a single spoke yoke design. The solenoid 200 may be similar to the toroid-shaped solenoid 100 in that the solenoid 200 includes a core 204 and a yoke 208 that approximate the toroid shape. In at least one example embodiment, the core 204 may be wrapped by a first coil 212 and the yoke 208 may be wrapped by a second coil 216. For example, the first coil 212 and the second coil 216 may be formed of the same material, such as wire. The first coil 212 may be electrically connected to the second coil 216. Alternatively, the first coil 212 may be electrically independent of the second coil 216.

The core 204 may be similar to the previously described core 14 and may include a plunger 220 and a stator core 224. The plunger 220 may move within an aperture 226 (or gap or air gap) within the stator core 224. The first coil 212 may be formed of wire and may be wound around a coil bobbin 228 that is inserted over the core 204. The core 204, coil bobbin 228, and first coil 212 assembly is surrounded by the yoke 208. In at least one example embodiment, the yoke 208 is a C-shaped yoke that connects to the core 204 on opposing ends. The C-shaped yoke 208 may include a yoke spoke 232 extending parallel to the core 204 and connected to the core 204 by arms 234 on each end extending orthogonal to the yoke spoke 232 and the core 204. In at least one example embodiment, the yoke spoke 232 may be an elongated plate that is wrapped by the second coil 216. For example, a plane on a face of the yoke spoke 232 may extend parallel with a longitudinal axis of the core 204. A shape of the second coil 216 on the yoke spoke 232 may be a stadium, or rounded rectangle.

The design of the solenoid 200 is an optimized design over the solenoid 10 in that the solenoid 200 increases the total number of windings (and thus increases the total magnetomotive force, mmf) by transferring the outermost windings from the typical bobbin 34 (i.e., solenoid 10) located around the stator core 26 to one or more spokes 232 of the yoke 208 (for example, one spoke as illustrated in FIGS. 3A and 3B). For example, the windings may be positioned on a bobbin 238 surrounding each of the one or more spokes 232 of the yoke 208. While the yoke 208 is illustrated and discussed as having one spoke 232, it is understood that this is for simplicity, and the solenoid 200 may include a yoke 208 having more than one spoke 232, such as two, three, four, five, six, or more spokes 232.

Transferring windings from the coil 30 in solenoid 10 to one or more coils (i.e., the second coil 216) located on one or more spokes 232 of the yoke 208 as in solenoid 200 is advantageous because each coil (i.e., the first coil 212 and the second coil 216, etc.) will have reduced volume (due to fewer layers of winding) and so an increased number of total windings may be accomplished in an equivalent packaging size or alternatively, an equivalent number of windings may be accomplished in a reduced packaging size. For example, the first coil 212 may be wound around the coil bobbin 228 in an equal number of layers as the number of layers the second coil 216 may be would around a bobbin on the yoke spoke 232. However, while it is described that the first coil 212 and the second coil 216 may have equal number of layers, it is understood that the number of layers of coil windings is design dependent, and the present disclosure is applicable for any number of layers of coil windings.

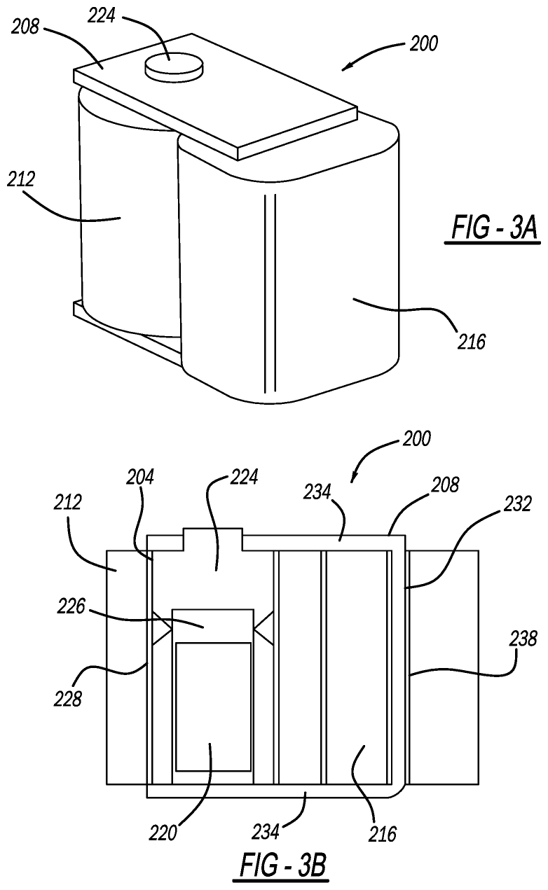

Referring to FIG. 4, at least one example embodiment of the magnetic circuit representation of the solenoid 200 is illustrated. As shown by the “X” and “O” indicators, the first coil 212 and the second coil 216 have current flowing in opposite directions (for example, current flows counterclockwise around the core 204 and current flows clockwise around the yoke 208), such that the portions of the first and second coils 212, 216 that are adjacent have current flowing in a direction into the page and the portions of the first and second coils 212, 216 on opposing sides of the solenoid 200 have current flowing in a direction out of the page. The arrangement of the first coil 212 and the second coil 216 having current flowing in opposite directions causes the first and second coils 212, 216 to act like a single coil around the stator, but have less layers, less wire, and smaller diameters. Alternatively, the first coil 212 and the second coil 216 may have current flowing in opposite directions, such that the portions of the first and second coils 212, 216 that are adjacent have current flowing in a direction out of the page and the portions of the first and second coils 212, 216 on opposing sides of the solenoid 200 have current flowing in a direction into the page.

In at least one example embodiment, the first coil 212 may be electrically connected to the second coil 216. Alternatively, the first coil 212 may be electrically independent of the second coil 216.

In at least one example embodiment, a flow of current through the solenoid 200 is shown by the arrows in FIG. 4. With the first coil 212 wound around the core 204 of the solenoid 200 and the second coil 216 wound around the yoke spoke 232 of the yoke 208, the magnetic circuit can be represented with a first source (NI) 236 located in the center of the core 204 of the solenoid 200 and a second source (NI) 240 located in the center of the yoke spoke 232 of the yoke 208. The first source (NI) 236 is equivalent to the number of turns of the first coil 212 multiplied by the current (i.e., supplied by a battery, for example), and the second source (NI) 240 is equivalent to the number of turns of the second coil 216 multiplied by the current. For reference, please see the previously discussed Magnetic “Ohm's Law” or Hopkinson's Law and Electrical Ohm's Law.

For example, as compared to solenoid 10, the magnetomotive force for first and second sources (NI) 236, 240 of solenoid 200 may individually be smaller than the magnetomotive force for the source (NI) 38 of the solenoid 10 because the coil 30 in solenoid 10 includes more turns and layers than the first coil 212 and the second coil 216 individually. However, the magnetomotive force for the first and second sources (NI) 236, 240 of solenoid 200, together, exceeds the magnetomotive force for the source (NI) 38 of the solenoid 10 because the first coil 212 and the second coil 216 are arranged to have more turns added together than the coil 30 in solenoid 10 where the same length of wire is used on both solenoid 10 and solenoid 200.

The first source (NI) 236 and second source (NI) 240 are similar to a “voltage source” in a magnetic circuit. The magnetic circuit representation for the solenoid 200 may include at least one resistor symbol 244 representing a magnetic reluctance. It is understood that the number of reluctances may be arbitrarily defined using the magnetic circuit representation.

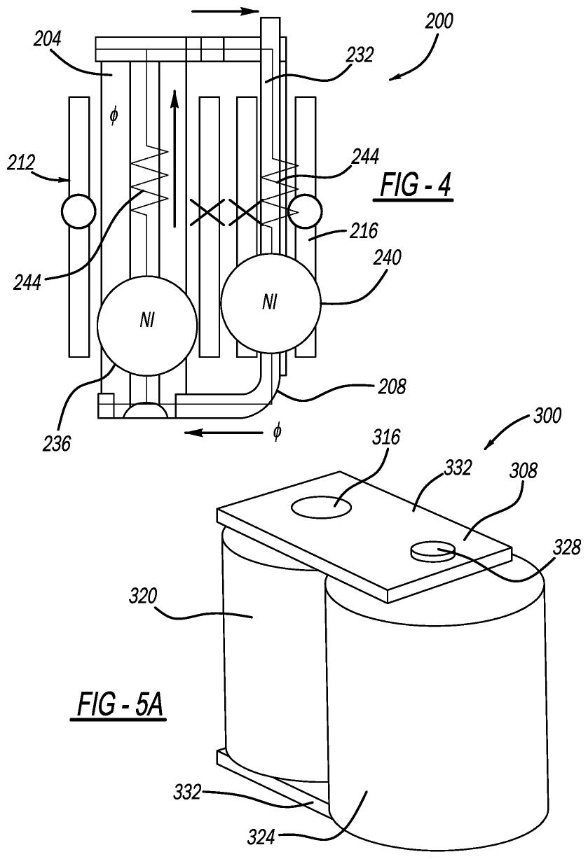

Now referring to FIGS. 5A and 5B, an alternative example embodiment to the example embodiment illustrated in FIGS. 3A and 3B is illustrated. A solenoid 300 includes a core 304 and a yoke 308. The core 304 may be similar to the previously described core 204 of solenoid 200 and may include a plunger 312 and a stator core 316. The plunger 312 may move within an aperture 318 (or gap or air gap) within the stator core 316. A first coil 320 may be formed of wire and may be wound around a coil bobbin 322 that is inserted over the stator core 316.

The core 304, coil bobbin 322, and first coil 320 assembly is surrounded by the yoke 308. In at least one example embodiment, the yoke 308 is a C-shaped yoke that connects to the core 304 on opposing ends. The C-shaped yoke 308 may include a yoke spoke 328 extending parallel to the core 304 and connected to the core 304 by arms 332 on each end extending orthogonal to the yoke spoke 328 and the core 304. A second coil 324 may be formed of wire and may be wound around a coil bobbin 326 on the yoke spoke 328 of the yoke 308. In at least one example embodiment, the second coil 324 may be wound around the coil bobbin 326 in an equal number of layers as the first coil 320. Alternatively, the second coil 324 may have more or fewer layers than the first coil 320. It is understood that the number of layers of coil windings is design dependent, and the present disclosure is applicable for any number of layers of coil windings.

In at least one example embodiment, the first coil 320 may be electrically connected to the second coil 324. Alternatively, the first coil 320 may be electrically independent of the second coil 324.

In at least one example embodiment, the yoke 308 may have a single yoke spoke 328. In at least one alternative example embodiment, the yoke 308 may have more than one yoke spoke 328, such as two, three, four, five, six, or more yoke spokes 328, each including a coil bobbin (for example, coil bobbin 326) being wound with a coil, such as the second coil 324.

In at least one example embodiment, the yoke spoke 328 of the yoke 308 may be a cylinder of approximately the same diameter as the plunger 312 and less than a diameter of the stator core 316. Alternatively, for example, a diameter of the yoke spoke 328 may be approximately the same as a diameter of the stator core 316. Alternatively, for example, a diameter of the yoke spoke 328 may be greater than a diameter of the stator core 316.

A longitudinal axis of the yoke spoke 328 may extend parallel with a longitudinal axis of the stator core 316 and plunger 312. Additionally, the yoke spoke 328 of the yoke 308 may be formed of an identical material, or a material having a nearly identical Saturation Flux Density, as the plunger 312, such that the yoke spoke 328 of the yoke 308 will not restrict a magnetic flux of the solenoid 300. Alternatively, the yoke spoke 328 may be formed of a material having a different Saturation Flux Density from the plunger 312.

In at least one example embodiment, in the case of the yoke spoke 328 of the yoke 308 being a cylinder of approximately the same diameter as the plunger 312 and less than a diameter of the stator core 316, the first coil 320 that wraps around the core 304 and the second coil 324 that wraps around the yoke spoke 328 of the yoke 308 may have approximately the same number of windings (plus or minus 5 windings). Alternatively, the first coil 320 that wraps around the core 304 and the second coil 324 that wraps around the yoke spoke 328 may have a different number of windings (either of the first coil 320 and the second coil 324 may have more windings than the other). In at least one example embodiment, the second coil 324 that wraps around the yoke spoke 328 may be cylindrical, similar to a shape of the yoke spoke 328 but with a larger diameter.

The solenoid 300 may have the same magnetic circuit representation as the solenoid 200 illustrated in FIG. 4. In at least one example embodiment, the windings of the solenoid 200 and the solenoid 300 may be connected so current in both the first coil 212, 320 and the second coil 216, 324 is controlled by the same controller. In an alternative example embodiment, the first coil 212, 320 and the second coil 216, 324 may be controlled with separate controllers to provide variable levels of solenoid force when desirable to do so.

In both the solenoid 200 and the solenoid 300, the wire on the first coil 212, 320 is connected to the wire on the second coil 216, 324 such that current flows in opposite directions, as previously described. In at least one example embodiment, the first coil 212, 320 may be electrically connected to the second coil 216, 324. Alternatively, the first coil 212, 320 may be electrically independent of the second coil 216, 324. For example, if the current flows clockwise around the stator core bobbin 228, 322, the current should flow counter-clockwise around any bobbins located on the yoke spoke 232, 328. The arrangement of current flow allows the magnitude of flux generated from each of the first coil 212, 320 and the second coil 216, 324 to be added together due to the vector direction of B-field according to the Biot-Savart Law:

$$d B = k \frac{Idl sin θ}{{r}^{2}}$$

where k is a constant that may, in the SI system of unit, may be

$$k = \frac{{μ}_{0} {μ}_{r}}{4 π}$$

such mat the final Biot-Savart law derivation is:

$$d B = \frac{{μ}_{0} {μ}_{r}}{4 π} * \frac{Idl sin θ}{{r}^{2}}$$

where dB is the magnetic field density at a point P, r is a distance-vector which makes an angle θ with the direction of current in the infinitesimal portion of the wire, μ₀ is the absolute permeability of air or vacuum, μᵣ is the relative permeability of the medium, I is current, and dl is an infinitely small length of wire at a distance r from point P.

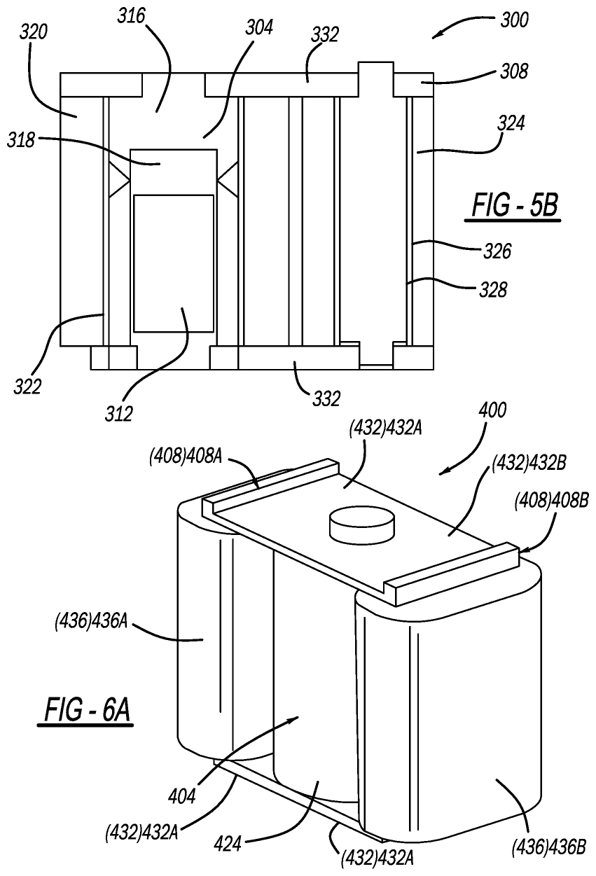

Now referring to FIGS. 6A and 6B, at least one example embodiment of a solenoid 400 according to the present disclosure is illustrated. The solenoid 400 may be a multi-spoke design. The solenoid 400 may be similar to the single-spoke solenoids 200, 300 and the toroid-shaped solenoid 100 in that the solenoid 400 includes a core 404 and a yoke 408, but in the solenoid 400, the yoke 408 is a plurality of yokes 408a, 408b, etc. that, with the core 404, approximate a number of toroid shapes linked together at the core 404.

In at least one example embodiment, the core 404 may be similar to the cores 204, 304 and may include a plunger 412 and a stator core 416. The plunger 412 may move within an aperture 418 (or gap or air gap) within the stator core 416. A coil bobbin 420 may be inserted over the stator core and a first coil 424 may be wound around the coil bobbin 420. In at least one example embodiment, the first coil 424 may be formed of wire.

The core 404, coil bobbin 420, and first coil 424 assembly is surrounded by the yokes 408. In at least one example embodiment, the yokes 408 are each a C-shaped yoke that connect to the core 404 on opposing ends. Each C-shaped yoke 408 may include a yoke spoke 428 (428A, 428B, etc.) extending parallel to the core 404 and connected to the core 404 by arms 432 (432A, 432B, etc.) on each end extending orthogonal to the yoke spoke 428 and the core 404. In the case of pairs of yokes 408, as shown in the figures, the yokes 408 may be disposed symmetrically, on opposite sides of the core 404.

In at least one example embodiment, each spoke 428 may include a coil bobbin 434 (434A, 434B, etc.) that is wrapped by a second coil 436 (436A, 436B, etc.). The second coil 436 may be formed of wire. For example, the second coil 436 may be wound around the coil bobbin 434 in an equal number of layers as the number of layers of the first coil 424. Alternatively, the second coil 436 may have a greater or fewer number of layers than the first coil 424. It is understood that the number of layers of coil windings is design dependent, and the present disclosure is applicable for any number of layers of coil windings.

In at least one example embodiment, the first coil 424 may be electrically connected to the second coil 436. Alternatively, the first coil 424 may be electrically independent of the second coil 436.

In at least one example embodiment, the yoke spoke 428 may be an elongated plate having the coil bobbin 434 that is wrapped by the second coil 436. For example, a plane on a face of the yoke spoke 428 may extend parallel with a longitudinal axis of the core 404. A shape of the second coil 436 on the coil bobbin 434 of the yoke spoke 428 may be a stadium, or rounded rectangle. In at least one alternative example embodiment, the yoke spoke 428 may have a cylindrical shape. For example, a longitudinal axis of the yoke spoke 428 may extend parallel with a longitudinal axis of the core 404. Thus, the shape of the second coil 436 on the coil bobbin 434 of the yoke spoke 428 may be a cylinder of a greater diameter than a diameter of the yoke spoke 428.

The design of the solenoid 400 is an optimized design over the solenoid 10 in that the solenoid 400 increases the total number of windings (and thus increases the total magnetomotive force, mmf) by transferring the outermost windings from the typical bobbin 34 (i.e., solenoid 10) located around the stator core 26 to one or more yoke spokes 428 of the yokes 408 (for example, two yoke spokes 428A, 428B and two yokes 408A, 408B, as illustrated in FIGS. 6A and 6B). While the solenoid 400 is illustrated and discussed as having two yokes 408A, 408B and two yoke spokes 428A, 428B, it is understood that this is for simplicity, and the solenoid 400 may include more than two yokes 408A, 408B and two yoke spokes 428A, 428B, such as three, four, five, six, or more yokes 408 and yoke spokes 428.

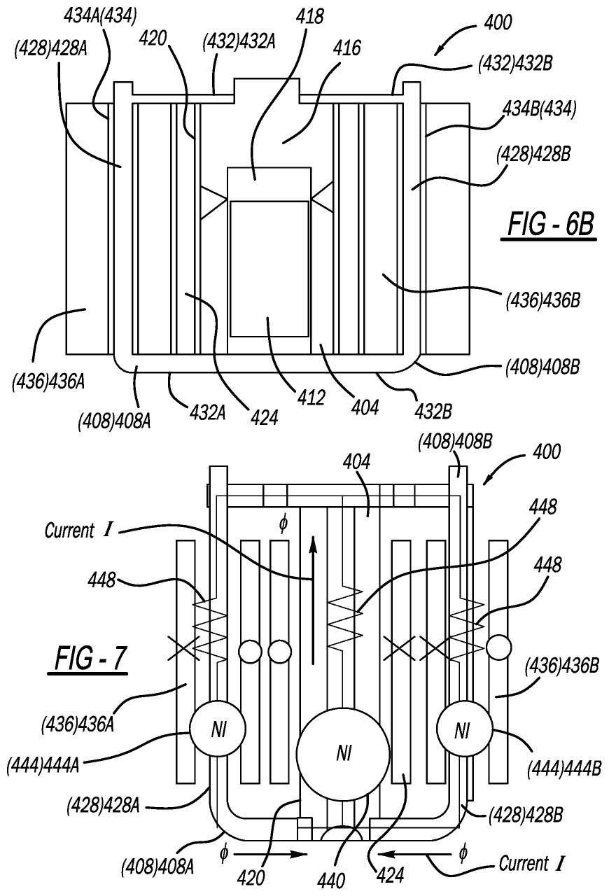

Now referring to FIG. 7, at least one example embodiment of the magnetic circuit representation of the solenoid 400 is illustrated. The explanation of the magnetic circuit representation of the solenoid 400 is similar to the explanation of the magnetic circuit representation of the solenoid 200, previously described, except that there is an additional yoke, yoke spoke, and coil. As shown by the “X” and “O” indicators, the first coil 424 on the core 404 includes current flowing in an opposite direction from the current flowing through the second coils 436 (436A, 436B) on the yokes 408 (408A, 408B), such that the portion of the first coil 424 and the second coil 436A on the first yoke 408A that are adjacent include current flowing in a direction into the page and the portions of the first coil 424 and the second coil 436A on the first yoke 408A that are on opposing sides of the solenoid 400 include current flowing in a direction out of the page. Likewise, the portion of the first coil 424 and the second coil 436B on the second yoke 408B that are adjacent both include current flowing in a direction out of the page and the portions of the first coil 424 and the second coil 436B on the second yoke 408B that are on opposing sides of the solenoid 400 include current flowing in a direction into the page. The arrangement of the first coil 424 and the second coils 436 (436A, 436B) having current flowing in opposite directions causes the first and second coils 424, 436 (436A, 436B) to have a similar effect as a single coil wound around the stator core with increased number of total windings, but requiring less wire due to the smaller individual diameters. Further, the use of multiple yokes 408 with second coils 436 allow for even fewer layers, less wire, and smaller diameters acting as a single coil around the stator core 416.

In at least one example embodiment, the first coil 424 may be electrically connected to each second coil 436. Alternatively, the first coil 424 may be electrically independent of each second coil 436. Further, the second coils 436a, 436b, etc. may be electrically connected to each other or may be electrically independent of each other.

In at least one example embodiment, a flow of flux through the solenoid 400 is shown by the arrows in FIG. 7. With the first coil 424 wound around the bobbin 420 on the core 404 of the solenoid 400 and the second coils 436 wound around the bobbins 434 on the yoke spokes 428 of the yokes 408, the magnetic circuit can be represented with a first source (NI) 440 located in the center of the core 404 of the solenoid 400 and a second source (NI) 444 (444A, 444B, etc.) located in a center of each yoke spoke 428 (428A, 428B, etc.) of the yokes 408 (408A, 408B, etc.). The first source (NI) 440 is equivalent to the number of turns of the first coil 424 multiplied by the current (i.e., supplied by a battery, for example), and each second source (NI) 444 (444A, 444B, etc.) is equivalent to the number of turns of the second coil 436 (436A, 436B, etc.) multiplied by the current. For reference, please see the previously discussed Magnetic “Ohm's Law” or Hopkinson's Law and Electrical Ohm's Law.

For example, as compared to solenoid 10, the magnetomotive force for first and second sources (NI) 440, 444 of solenoid 400 may individually be smaller than the magnetomotive force for the source (NI) 38 of the solenoid 10 because the coil 30 in solenoid 10 includes more turns and layers than the first coil 424 and the second coils 436 individually. However, the magnetomotive force for the first and second sources (NI) 440, 444 of solenoid 400, together, exceeds the magnetomotive force for the source (NI) 38 of the solenoid 10 because the first coil 424 and the second coils 436 are arranged to have more turns added together than the coil 30 in solenoid 10 where the same length of wire is used on both solenoid 10 and solenoid 400.

Likewise, as compared to solenoids 100, 200, and 300, the magnetomotive force for first and second sources (NI) 440, 444 of solenoid 400 may individually be smaller than the current for the source (NI) 236, of the solenoids 100, 200, 300 because the coils 120, 212, 216, 320, 324 in solenoids 100, 200, 300 include more turns and layers than the first coil 424 and the second coils 436 individually. However, the magnetomotive force for the first and second sources (NI) 440, 444 of solenoid 400, together, exceeds the magnetomotive force for the source (NI) 236 of the solenoids 100, 200, 300 because the first coil 424 and the second coils 436 are arranged to have more turns added together than the coils 120, 212, 216, 320, 324 in solenoids 100, 200, 300 where the same length of wire is used on both solenoid 400 and solenoids 100, 200, 300.

The first source (NI) 440 and second sources (NI) 444 are similar to a “voltage source” in a magnetic circuit. The magnetic circuit representation for the solenoid 400 may include at least one resistor symbol 448 representing a magnetic reluctance. The at least one resistor symbol 448 may be positioned on the core 404, one or more of the yoke spokes 428, or both. It is understood that the number of reluctances may be arbitrarily defined using the magnetic circuit representation.

The solenoid 400 is optimized over the toroid designed solenoid 100 in that the design of the solenoid 400 is much easier to implement. The solenoid 400 solves potential problems with the traditional solenoid 10 like the yoke cross sectional area being too small resulting in excessive leakage flux due to magnetic saturation and uneven flux around the stator circumference due to only one spoke. Further, the solenoid 400 may allow for more effective windings at smaller diameters compared to a single spoke yoke.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A solenoid comprising:
a core;
a yoke; and
a first coil wound around the yoke.

2. The solenoid of claim 1, wherein a second coil is wound around the core, the second coil being electrically connected to the first coil.

3. The solenoid of claim 2, wherein the core includes a stator core and a coil bobbin, the coil bobbin is located around the stator core, and the second coil is wound around the coil bobbin.

4. The solenoid of claim 3, wherein the core includes a plunger disposed within an aperture defined by the stator core.

5. The solenoid of claim 4, wherein a diameter of the yoke is the same as a diameter of the plunger.

6. The solenoid of claim 3, wherein a diameter of the yoke is less than a diameter of the stator core.

7. The solenoid of claim 2, wherein the yoke includes a yoke spoke and a yoke bobbin, the yoke bobbin is located around the yoke spoke and the first coil is wound around the yoke bobbin.

8. The solenoid of claim 7, wherein the yoke spoke is a cylindrical yoke spoke, the yoke bobbin is a cylindrical bobbin, and the first coil is located around the yoke bobbin in a cylindrical shape.

9. The solenoid of claim 7, wherein the yoke spoke is a plate-shaped yoke spoke and the first coil is located around the yoke bobbin in a stadium shape.

10. The solenoid of claim 7, wherein the yoke spoke extends parallel to the core and is attached to the core by arms extending between a top end of the core and a top end of the yoke spoke and between a bottom end of the core and a bottom end of the yoke spoke.

11. The solenoid of claim 2, wherein the yoke is one of a pair of yokes and the first-coil is one of a pair of first coils, each of the pair of yokes including a yoke spoke, and one of the pair of first coils being wound around the yoke spoke on each of the pair of yokes.

12. The solenoid of claim 11, wherein the pair of yokes are disposed symmetrically and on opposing sides of the core.

13. The solenoid of claim 11, wherein the yoke spoke is a cylindrical yoke spoke and the first coil is located around the yoke spoke in a cylindrical shape.

14. The solenoid of claim 11, wherein each of the pair of first coils is supplied current around the spoke in a first direction and the second coil is supplied current around the core in a second direction, the second direction being opposite the first direction.

15. The solenoid of claim 2, wherein the first coil is supplied current around the yoke in a first direction and the second coil is supplied current around the core in a second direction, the second direction being opposite the first direction.

16. The solenoid of claim 15, wherein the first direction is counter-clockwise around the yoke and the second direction is clockwise around the core.

17. The solenoid of claim 15, wherein the first direction is clockwise around the yoke and the second direction is counter-clockwise around the core.

18. A solenoid comprising:
a core extending in a toroidal shape or a toroid-like shape; and
a first coil disposed around the core.

19. The solenoid of claim 1, wherein the first coil is disposed on an entirety of the core.

20. The solenoid of claim 1, wherein the first coil is disposed on a portion of the core.
